(19) United States
(12) Patent Application Publication
(10) Pub. No.: US 2026/0005371 A1
(43) Pub. Date: Jan. 1, 2026

(54) ENERGY STORAGE POWER SUPPLY

(71) Applicant: SHENZHEN HELLO TECH ENERGY CO., LTD., Longhua District Shenzhen (CN)

(72) Inventors: Zhen HE, Longhua District Shenzhen (CN); Zhongwei SUN, Longhua District Shenzhen (CN); Yongjun CHEN, Longhua District Shenzhen (CN)

(21) Appl. No.: 19/095,262

(22) Filed: Mar. 31, 2025

Related U.S. Application Data
(63) Continuation of application No. PCT/CN2025/073847, filed on Jan. 22, 2025.

(30) Foreign Application Priority Data
Jun. 28, 2024 (CN) CN 202410869223.5
Jun. 28, 2024 (CN) CN 202421528422.1

(51) Int. Cl. H01M 50/256; H01M 10/42; H01M 50/213; H01M 50/251; H01M 50/262; H01M 50/291; H01M 50/507

(52) U.S. Cl. CPC H01M 50/256; H01M 10/425; H01M 50/213; H01M 50/251; H01M 50/262; H01M 50/291; H01M 50/507; H01M 2010/4271; H01M 2220/10

(57) ABSTRACT

Provided is an energy storage power supply, including: a housing formed with first positioning holes; a battery module including a holder and battery cells, where the holder cooperates with the housing to accommodate the battery cells and formed with second positioning holes, each battery cell has a first end and a second end opposite to the first end, the first ends of the battery cells are respectively inserted into the first positioning holes, and the second ends of the battery cells are respectively inserted into the second positioning holes; first electrical connectors disposed on one side of the housing away from the battery module and electrically connected to the first ends of the battery cells; an inverter disposed on the holder and electrically connected to the battery module; and a pull rod housing disposed on the housing and covering the first electrical connectors.

### CROSS-REFERENCE TO RELATED APPLICATIONS

The present application is a continuation of International Application No. PCT/CN2025/073847, filed on Jan. 22, 2025, which claims the priority of the Chinese patent application No. 202410869223.5, filed on Jun. 28, 2024, and Chinese patent application No. 202421528422.1, filed on Jun. 28, 2024, all of which are incorporated herein by reference in their entirety.

### TECHNICAL FIELD

The present application relates to the technical field of energy storage equipment, and in particular, to an energy storage power supply.

### BACKGROUND

In the related art, generally, two battery holders are used to fix two ends of a battery cell respectively, along with the corresponding electrical connectors and the collection boards to form a battery pack, and then the battery pack is mounted into a housing. As such, an energy storage power supply has a large number of components, a large volume, high cost, and complex mounting processes. On the other hand, since the housing needs to reserve a mounting space for the battery pack, the volume of the energy storage power supply is further increased.

### SUMMARY

An implementation of the present application provides an energy storage power supply.

The energy storage power supply according to the implementation of the present application includes:
a housing formed with a plurality of first positioning holes;
a battery module including a plurality of battery cells, where one end of each of the plurality of battery cells is inserted into one of the plurality of first positioning holes;
first electrical connectors disposed on one side of the housing away from the battery module and electrically connected to the plurality of battery cells; and
a pull rod housing disposed on the housing and covering the first electrical connectors.

According to the energy storage power supply provided by an embodiment of the present application, by using the pull rod housing to replace a cover plate to cover the first electrical connectors, the battery cells are protected and the misconnection of the battery cells is avoided, and at the same time, components can also be saved, which is beneficial to reducing the assembling processes and the cost. In addition, the housing is used to replace a battery holder, which is beneficial to improving the space utilization rate of the product, reducing the product size, further reducing the assembling steps, improving the assembling efficiency, and reducing the part cost.

In some embodiments, the pull rod housing includes a first housing and a retractable pull rod mounted in the first housing, and the first housing covers the electrical connectors.

As such, the retractable pull rod is disposed on the first housing to facilitate the carrying of the energy storage power supply.

In some embodiments, the battery module includes a holder, and one end of each of the plurality of battery cells away from the housing is inserted into the holder.

As thus, the holder is used to assist in fixing the battery cells, which is beneficial to simplifying the assembly of the battery cells.

In some embodiments, the housing is fastened and connected to the holder.

As such, the fastening connection between the housing and the holder facilitates the maintenance and replacement of the housing and the holder.

In some embodiments, the housing includes a plurality of first connection columns, the holder includes a plurality of second connection columns, and in a case where the housing is connected to the holder, the first connection columns are connected to the second connection columns.

As such, the first connection columns and the second connection columns are used to connect the housing and the holder. Moreover, the provision of the first connection columns is beneficial to improving the structural strength of the housing, and the provision of the second connection columns is beneficial to improving the structural strength of the holder.

In some embodiments, the holder is formed with a plurality of second positioning holes respectively corresponding to the plurality of first positioning holes.

As such, the second positioning holes are used for fixing the battery cells together with the first positioning holes, which is beneficial to fixing the battery cells more stably, and at the same time, the battery cells can be pre-assembled on the holder to facilitate the assembly of the battery cells.

In some embodiments, the energy storage power supply further includes second electrical connectors disposed on one side of the holder away from the battery cells and electrically connected to the battery cells.

As such, the second electrical connectors can balance the current and the overvoltage protection, reduce the damage and replacement frequency of the battery cells, thereby reducing the maintenance cost of the battery module.

In some embodiments, the energy storage power supply further includes an insulating layer disposed between the first electrical connectors and the pull rod housing.

As such, the insulating layer can effectively isolate the first electrical connectors from the pull rod housing, avoiding a metal piece on the pull rod housing from touching the first electrical connectors by mistake to cause electric leakage or short circuit.

In some embodiments, the energy storage power supply further includes collection boards connected to the plurality of first electrical connectors.

As such, the provision of the collection boards is beneficial to achieving real-time monitoring and data collection of the battery parameters.

In some embodiments, the energy storage power supply further includes an inverter electrically connected to the battery module and mounted on the holder.

As such, the inverter is used to assist in the heat dissipation of the battery module, which is beneficial to prolonging the service life of the battery module.

In some embodiments, the pull rod housing is disposed on a side face or a bottom of the energy storage power supply.

As such, the pull rod can be disposed on the side face or the bottom of the energy storage power supply according to the requirements.

In some embodiments, the energy storage power supply further includes rollers mounted on a bottom of the first housing.

As such, it is convenient for a user to move the energy storage power supply, reducing the carrying burden.

In some embodiments, the energy storage power supply further includes a roller housing fixed to a bottom of the energy storage power supply including a second housing and rollers mounted in the second housing.

As such, it is convenient for a user to move the energy storage power supply, reducing the carrying burden.

### BRIEF DESCRIPTION OF DRAWINGS

FIG. 1 is a structural schematic diagram of a partial structure of an energy storage power supply according to an implementation of the present application;

FIG. 2 is an assembly diagram of a partial structure of an energy storage power supply according to an implementation of the present application;

FIG. 3 is an exploded schematic diagram of an energy storage power supply according to an implementation of the present application;

FIG. 4 is a cross-sectional view of a partial structure of an energy storage power supply according to an implementation of the present application; and

FIG. 5 is a side view of a partial structure of an energy storage power supply according to an implementation of the present application.

Reference signs: energy storage power supply 100, housing 10, first positioning hole 11, first connection column 12, left decorative cover 13, right decorative cover 14, front decorative cover 15, top cover 16, bottom cover 17, battery module 20, battery cell 21, holder 22, second connection column 221, second positioning hole 222, first electrical connector 30, pull rod housing 40, first housing 41, pull rod 42, second electrical connector 50, insulating layer 60, collection board 70, inverter 80, roller housing 90, roller 91, and handle assembly 10a.

### DESCRIPTION OF EMBODIMENTS

In the related art, generally, two battery holders are used to fix two ends of a battery cell respectively, along with the corresponding electrical connectors and the collection boards to form a battery pack, and then the battery pack is mounted into a housing. As such, an energy storage power supply has a large number of components, a large volume, high cost, and complex mounting processes. On the other hand, since the housing needs to reserve a mounting space for the battery pack, the volume of the energy storage power supply is further increased.

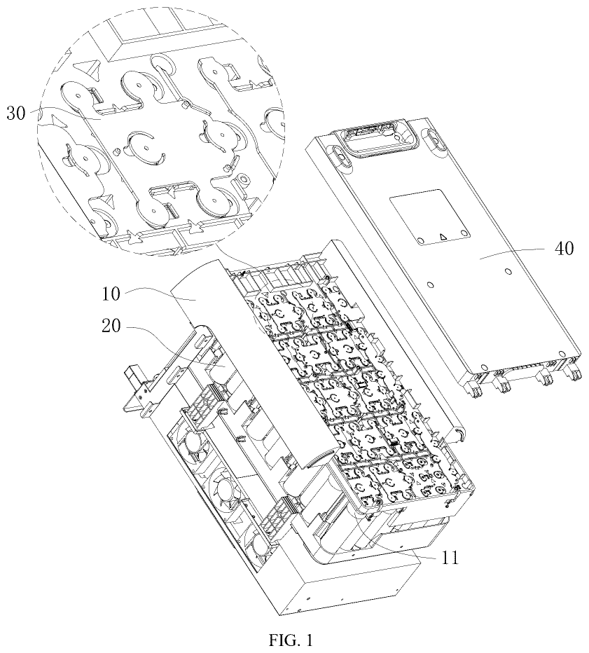

Referring to FIG. 1, an energy storage power supply 100 according to an implementation of the present application includes a housing 10, a battery module 20, first electrical connectors 30, and a pull rod housing 40. The housing 10 is formed with a plurality of first positioning holes 11. The battery module 20 includes a plurality of battery cells 21, and one end of each of the plurality of battery cells 21 is inserted into one of the plurality of first positioning holes 11. The first electrical connectors 30 are disposed on one side of the housing 10 away from the battery module 20 and is electrically connected to the plurality of battery cells 21. The pull rod housing 40 is disposed on the housing 10 and covers the first electrical connectors 30.

According to the energy storage power supply 100 provided by an embodiment of the present application, by using the pull rod housing 40 to replace a cover plate to cover the first electrical connectors, the battery cells 21 are protected and the misconnection of the battery cells 21 is avoided, and at the same time, components can also be saved, which is beneficial to reducing the assembling processes and the cost. In addition, the housing 10 is used to replace a battery holder 22, which is beneficial to improving the space utilization rate of the product, reducing the product size, further reducing the assembling steps, improving the assembling efficiency, and reducing the part cost. A first through-hole is disposed in the first positioning hole and is used to fix the battery cell. When the battery cell is fixed in the first positioning hole, the first through-hole serves to expose the electrode of the battery cell so that it can be electrically connected to the first electrical connector.

Specifically, the energy storage power supply 100 is a device that is capable of storing electric energy and releasing it when needed, and its main function is to provide a stable and reliable power supply. When a system needs to store electric energy, a controller charges a battery pack, and the battery pack converts the electric energy into chemical energy for storage. When the system needs to use electric energy, the controller first converts direct current electric energy stored in the battery pack into alternating current electric energy which then is output.

In an embodiment of the present application, an accommodating cavity is formed in the housing 10, and the battery module 20 is disposed in the accommodating cavity.

The battery module 20 includes the plurality of battery cells 21. The battery cells 21 are disposed in an upright array, that is, a length direction of the battery cells 21 is provided along a vertical direction to ensure that the space occupation is minimized.

In further embodiments, the plurality of battery cells 21 may also be disposed in an array along other directions according to actual needs.

In some embodiments, each of the battery cells 21 has two electrodes, and the two electrodes are respectively disposed on two opposite sides of the battery cell 21. When the battery cells are disposed in an array, the electrodes are respectively concentrated on two sides of the battery pack to facilitate the connection among the battery cells 21.

In some embodiments, each of the battery cells 21 has two electrodes, and two electrodes are disposed on the same side of the battery cell 21. When the battery cells are disposed in an array, the electrodes should be concentrated on the same side of the battery pack to facilitate the connection among the battery cells 21.

The first electrical connectors 30 are busbars, which are devices with high conductivity, stability, and reliability, and are used to concentrate or disperse current. In the electrical field, a busbar is also known as a bus, a bus bar, etc., and is used to connect a plurality of electrical lines. The busbar is made of a material with high conductivity to ensure the high efficiency of current transmission. The busbar also has good current carrying and transmission capabilities, and can quickly respond to a change in the power grid to ensure the stable operation of the power grid.

The first electrical connectors 30 can alternately connect the positive pole columns and negative pole columns of the at least one battery cell 21 in sequence, such that the positive pole column and the negative pole column connected to the two ends of the first electrical connectors 30 serve as a positive wiring port and a negative wiring port respectively. That is, the first electrical connectors 30 connect the at least one battery cell 21 in series, so that the at least one battery cell 21 form an output power supply with a high voltage, thereby ensuring that the power demand of a user is met.

In this embodiment, the first electrical connectors 30 are plate-shaped, and each of the first electrical connectors 30 connects six battery cells 21 to achieve the series connection among the six battery cells 21. The first electrical connectors 30 can be made of copper, aluminum, nickel, or alloy materials. After the first electrical connectors 30 are fixed to the correct positions by a working fixture, the first electrical connectors 30 and the electrodes of the battery cells 21 can be welded together by laser welding. It can be understood that the electrical connection between the first electrical connectors 30 and the electrodes of the battery cells 21 can also be achieved through other connection methods such as twisting or pressing.

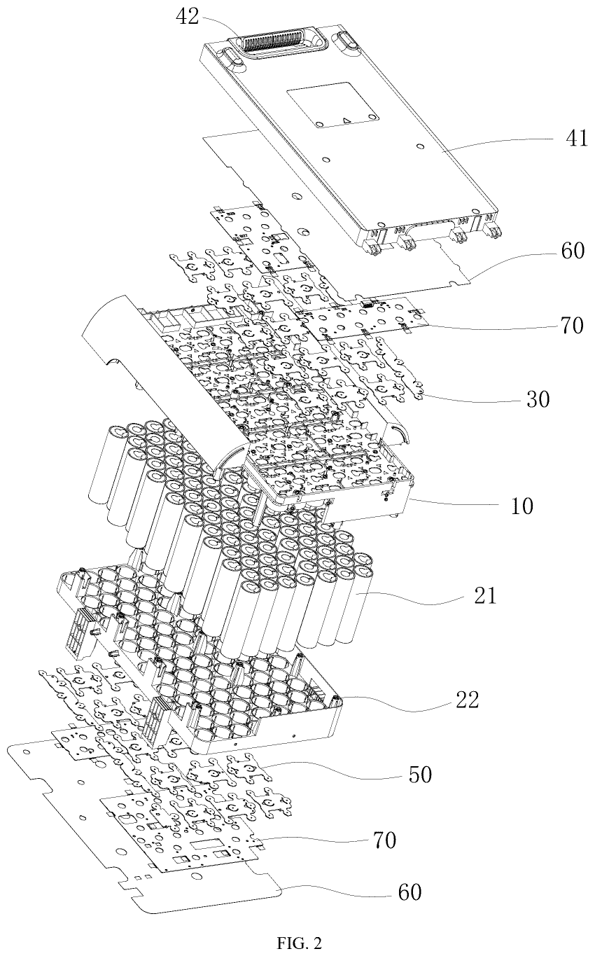

Referring to FIG. 2, in some embodiments, the housing 10 is a rear housing of the energy storage power supply 100. The pull rod housing 40 includes a first housing 41 and a retractable pull rod 42 mounted in the first housing 41. The first housing 41 covers the electrical connectors.

As such, the pull rod housing 40 is disposed on the rear housing to facilitate the carrying of the energy storage power supply 100.

In an embodiment of the present application, the pull rod housing 40 can be disposed on the side face, the bottom, or the top of the energy storage power supply 100, and correspondingly, the pull rod 42 can also be disposed on the side face, the bottom, or the top of the energy storage power supply 100, which specifically may be set up according to the actual situation, and will not be limited herein.

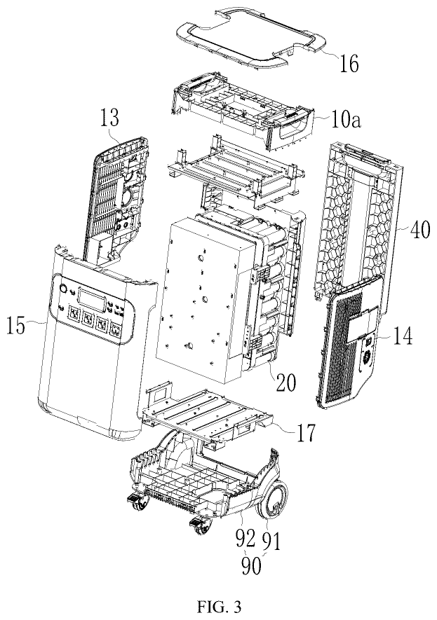

Referring to FIG. 3, in some embodiments, the energy storage power supply 100 further includes rollers 91 mounted on the bottom of the first housing 41. In this embodiment, the rollers 91 may be provided in two, and two supporting portions (not shown) are disposed on the opposite side of the two rollers 91. When the energy storage power supply 100 is moved, the pull rod 42 is pulled to tilt the energy storage power supply 100 towards the side of the rollers 91, and thus the supporting portions are lifted. With the cooperation of the pull rod 42 and the rollers 91, the energy storage power supply 100 is pulled to move, reducing the carrying burden. When the energy storage power supply 100 is placed, the energy storage power supply 100 is horizontally placed, so that the supporting portions and the rollers 91 stably support the energy storage power supply 100, and the movement of the energy storage power supply 100 is restricted by the supporting portions. Alternatively, in some embodiments, the energy storage power supply 100 further includes a roller housing 90. The roller housing 90 can be fixed to the bottom of the energy storage power supply. The roller housing 90 includes a second housing 92 and rollers 91 mounted in the second housing. In this embodiment, the rollers 91 can be provided in four. Two rollers 91 disposed on the same side as the pull rod 42 can be provided as large rollers, and the other two rollers 91 can be provided as small rollers. Moreover, the small rollers are provided with brake pads, that is, the small rollers are brake wheels, which facilitate locking the energy storage power supply 100 and preventing the energy storage power supply 100 from slipping randomly.

Specifically, the pull rod 42 includes a handle and connecting rods. Generally, the number of the connecting rods is two, and the two connecting rods are respectively mounted at the two ends of the handle.

In an embodiment of the present application, the handle is made of a metal material. Specifically, an aluminum alloy material can be selected, and the interior of which is subjected to hollow treatment, which is beneficial to the lightweight of the energy storage power supply 100. Moreover, the handle of aluminum alloy has higher strength and durability, which is beneficial to increasing the reliability of the handle and prolonging its service life.

Further, the rear housing is provided with a mounting groove. The pull rod housing 40 is disposed in the mounting groove, and the handle can extend out of the mounting groove and be exposed outside the housing 10.

In other embodiments, the handle can also be made of other materials, which specifically may be set up according to the actual situation, and will not be limited herein.

In other embodiments, the handle can also be provided as a flexible handle. The flexible handle has good adaptability and flexibility, as well as better comfort and touch feeling.

In an embodiment of the present application, the connecting rods are slidably disposed in the pull rod housing 40.

In some embodiments, sliding grooves are disposed in the pull rod housing 40, and the connecting rods are slidably disposed in the sliding grooves.

Further, in some embodiments, the connecting rods are provided with elastic locking pins, and the side walls of the sliding grooves are provided with locking holes that cooperate with the elastic locking pins. When the connecting rods are pulled out to the position where the handle is farthest from the pull rod housing 40 or retracted to the position where the handle is closest to the pull rod housing 40, the elastic locking pins are inserted into the locking holes to lock the handle.

Further, in some embodiments, a control button is disposed on the handle. The control button is used to control the elastic locking pins to retract, so that the elastic locking pins are pulled out of the locking holes to achieve unlocking.

In an embodiment of the present application, the connecting rods are made of a pipe made of a metal material. In this embodiment, the connecting rods are square tubes made of stainless steel.

Further, with continued reference to FIG. 3, in some embodiments, the energy storage power supply 100 further includes a handle assembly 10a disposed on the top of the energy storage power supply. If the energy storage power supply 100 cannot be pulled to move by the pull rods 42, the user can lift and carry the energy storage power supply 100 by holding the handle assembly 10a.

Further, with continued reference to FIG. 3, in some embodiments, the housing 10 includes a left decorative cover 13, a right decorative cover 14, a front decorative cover 15, a top cover 16, and a bottom cover 17. The left decorative cover 13, the right decorative cover 14, the front decorative cover 15, the pull rod housing 40, the top cover 16, and the bottom cover 17 are connected to form an accommodating cavity for disposing the battery module 20.

Further, in some embodiments, the cross-sectional shapes of the sliding grooves that cooperate with the connecting rods are also square.

In some embodiments, the battery module 20 includes a holder 22, and one end of each of the plurality of battery cells 21 away from the housing 10 is inserted into the holder 22.

As such, the holder 22 is used to assist in fixing the battery cells 21, which is beneficial to simplifying the assembly of the battery cells 21.

Specifically, the plurality of battery cells 21 of the battery module 20 are disposed in an array inside the holder 22 and fixed, which facilitates the disassembly and maintenance of the battery module 20.

In some embodiments, the housing 10 is fastened and connected to the holder 22.

As such, the fastening connection between the housing 10 and the holder 22 facilitates the maintenance and replacement of the housing 10 and the holder 22.

In an embodiment, the fastening connection between the housing 10 and the holder 22 is an important link to ensure the stability and safety of the internal structure of the energy storage power supply 100. In an embodiment of the present application, the connection type is selected as bolted connection.

Bolted connection is one of the most common means for fastening and connecting the housing 10 and the holder 22. Through the cooperation of bolts and nuts, the housing 10 and the holder 22 are tightly connected together. Bolted connection has the advantages of simple structure, convenient disassembly, and strong bearing capacity and the like.

Further, according to application requirements, different types of bolts, such as ordinary bolts, high-strength bolts, etc., can be selected. High-strength bolts have better performance when subjected to a larger load.

It should be noted that the fastening torque of the bolted connection is one of the key parameters, which needs to be calculated and set according to specific materials and structures. A suitable fastening torque can ensure the stability and safety of the connection.

In some embodiments, other connectors or fasteners may also be selected to connect the housing 10 and the holder 22. The connector is a component for connecting the housing 10 and the holder 22 together, such as a bolt, a nut, and a washer. The selection and mounting of the connector have an important impact on the stability and safety of the connection. The material of the connector should have good mechanical properties and chemical stability to adapt to different working environments and load requirements. The selection of the size of the connector should be calculated and determined according to the size and load requirements of the housing 10 and the holder 22.

The fasteners are components for fixing the connector, such as wrenches, screwdrivers and the like. The selection and use of the fasteners have an important impact on the tightness and stability of the connection. A suitable fastener should be selected according to the type and size of the connector. When using the fastener, the magnitude of the fastening force needs to be controlled to ensure the stability and safety of the connection. Excessive fastening force may cause damage or deformation of the connector, while insufficient fastening force may lead to unstable connection.

In some embodiments, the housing 10 and the holder 22 can also be connected by welding. Welding connection has the advantages of high connection strength, good sealing performance and the like, but compared with bolted connection, welding connection is more difficult to disassemble and maintain.

Further, different welding types, such as spot welding, seam welding and the like, can be selected according to materials and application requirements.

It should be noted that the welding quality directly affects the stability and safety of the connection. Therefore, during the welding process, the welding parameters and quality need to be strictly controlled to ensure that the welding quality meets the relevant standards and requirements.

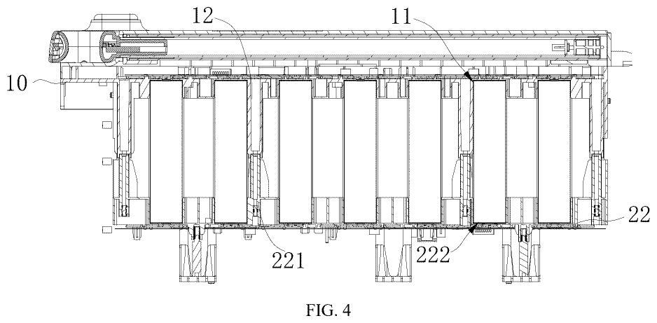

Referring to FIG. 4, in some embodiments, the housing 10 includes a plurality of first connection columns 12, the holder 22 includes a plurality of second connection columns 221, and in a case where the housing 10 is connected to the holder 22, the first connection columns 12 are connected to the second connection columns 221.

As such, the first connection columns 12 and the second connection columns 221 are used to connect the housing 10 and the holder 22. Moreover, the provision of the first connection columns 12 is beneficial to improving the structural strength of the housing 10, and the provision of the second connection columns 221 is beneficial to improving the structural strength of the holder 22.

Specifically, in an embodiment of the present application, the first connection columns 12 are disposed on a first inner wall of the rear housing 10, and the plurality of first connection columns 12 are disposed in an array of multiple rows and multiple columns. Similarly, the second connection columns 221 are disposed on a second inner wall of the holder 22, and the plurality of second connection columns 221 are disposed in an array of multiple rows and multiple columns.

Further, the first connection columns 12 and the housing are integrally formed as an integrated structure, and the second connection columns 221 and the holder are integrally formed as an integrated structure.

In some embodiments, since the lengths of the first connection columns 12 and the second connection columns 221 are longer, in order to improve their structural strength, the housing is further provided with first reinforcing ribs. The first reinforcing ribs are triangular or trapezoidal, and each of the first reinforcing ribs has one end connected to the first inner wall and the other end connected to one of the first connection columns 12. Similarly, the housing is also provided with second reinforcing ribs. The second reinforcing ribs are triangular or trapezoidal, and each of the second reinforcing rib has one end connected to the second inner wall and the other end connected to one of the second connection columns 221.

Further, each of the first connection columns 12 is connected to a plurality of first reinforcing ribs. Similarly, each of the second connection columns 221 is connected to a plurality of second reinforcing ribs. In an embodiment of the present application, each of the first connection columns 12 is connected to at least three first reinforcing ribs. Similarly, each of the second connection columns 221 is connected to at least three second reinforcing ribs.

In some embodiments, the holder 22 is formed with a plurality of second positioning holes 222 respectively corresponding to the plurality of first positioning holes 11.

As such, the second positioning holes 222 are used for fixing the battery cells 21 together with the first positioning holes 11, which is beneficial to fixing the battery cells 21 more stably, and at the same time, the battery cells 21 can be pre-assembled on the holder 22 to facilitate the assembly of the battery cells 21.

Specifically, the first positioning holes 11 and the second positioning holes 222 are used for fixing the battery module 20.

Specifically, the first positioning holes 11 are disposed on the first inner wall of the rear housing, and the second positioning holes 222 are disposed on the second inner wall of the holder 22.

Further, there are a plurality of first positioning holes 11, and the plurality of first positioning holes 11 are disposed in an array. There are a plurality of second positioning holes 222, and the plurality of second positioning holes 222 are disposed in an array. The second positioning holes 222 are disposed in one-to-one correspondence with the first positioning holes 11. In this embodiment, the battery module 20 includes a plurality of battery cells 21 disposed in an array. One second positioning hole 222 cooperates with one first positioning hole 11 to fix one of the battery cells 21 of the battery module 20.

In this embodiment, the plurality of first connection columns 12 are disposed at intervals between the plurality of first positioning holes 11, and the plurality of second connection columns 221 are disposed at intervals between the plurality of second positioning holes 222.

In some embodiments, the first positioning hole 11 can also be defined between two adjacent rows of the first connecting posts 12 and two adjacent columns of the first connecting posts 12. The array arrangement of the plurality of first connection columns 12 enables the first positioning holes 11 to be disposed at intervals.

Similarly, the second positioning hole 222 can be defined between two adjacent rows of the second connection columns 221 and two adjacent columns of the second connection columns 221. The array arrangement of the plurality of second connection columns 221 enables the second positioning holes 222 to be disposed at intervals.

It can be understood that by forming the first positioning holes 11 and the second positioning holes 222 disposed at intervals through the plurality of first connection columns 12 and the plurality of second connection columns 221, it can be ensured that the plurality of battery cells 21 are disposed at intervals, reducing problem of thermal expansion and the like caused by the direct contact between the plurality of battery cells 21, as well as reducing the situation where the plurality of battery cells 21 are squeezed and deformed due to the collision of the energy storage power supply 100, thereby reducing the safety risk.

In some embodiments, the first positioning hole 11 which is cylindrical and the second positioning hole 222 which is cylindrical can be respectively defined between two adjacent rows of the first connecting posts 12 and two adjacent columns of the first connecting posts 12 and between two adjacent rows of the second connection columns 221 and two adjacent columns of the second connection columns 221, to ensure the stable placement of the battery cells 21 which are cylindrical and in turn improves the stability of the cylindrical battery cells 21.

In detail, an outer peripheral wall of each of the first connection columns 12 and an outer peripheral wall of each of the second connection columns 221 are formed as arc-shaped faces to enclose the cylindrical first positioning hole 11 and the cylindrical second positioning hole 222, so that the cylindrical holes match the outer peripheral walls of the battery cells 21, which in turn ensures the connection effect between the battery cells 21 and the positioning parts and reduce the shaking phenomenon.

In other embodiments, the first positioning holes 11 and the second positioning holes 222 may also be in other shapes, such as rectangles and the like to ensure that the battery cells 21 with different shapes are stably placed, which is not specifically limited herein.

Referring to FIG. 2, in some embodiments, the energy storage power supply 100 further includes second electrical connectors 50 disposed on one side of the holder 22 away from the battery cells 21 and electrically connected to the plurality of battery cells 21.

As such, the second electrical connectors 50 can balance the current and the overvoltage protection, reduce the damage and replacement frequency of the battery cells 21, thereby reducing the maintenance cost of the battery module 20.

Specifically, the second electrical connectors 50 are busbars, which are devices with high conductivity, stability, and reliability, and are used to concentrate or disperse current. In the electrical field, a busbar is also known as a bus, a bus bar, etc., and is used to connect a plurality of electrical lines. The busbar is made of a material with high conductivity to ensure the high efficiency of current transmission. The busbar also has good current carrying and transmission capabilities, and can quickly respond to a change in the power grid to ensure the stable operation of the power grid.

The second electrical connectors 50 can alternately connect the positive pole columns and negative pole columns of the at least one battery cell 21 in sequence, such that the positive pole column and the negative pole column connected to the two ends of the second electrical connectors 50 serve as a positive wiring port and a negative wiring port respectively. That is, the second electrical connectors 50 connect the at least one battery cell 21 in series, so that the at least one battery cell 21 form an output power supply with a high voltage, thereby ensuring that the power demand of a user is met.

In this embodiment, the second electrical connectors 50 are plate-shaped, and each of the second electrical connectors 50 connects six battery cells 21 to achieve the series connection among the six battery cells 21. The second electrical connectors 50 can be made of copper, aluminum, nickel, or alloy materials. After the second electrical connectors 50 are fixed to the correct positions by a working fixture, the second electrical connectors 50 and the electrodes of the battery cells 21 can be welded together by laser welding. It can be understood that the electrical connection between the second electrical connectors 50 and the electrodes of the battery cells 21 can also be achieved through other connection methods such as twisting or pressing.

In some embodiments, the energy storage power supply 100 further includes an insulating layer 60 disposed between the first electrical connectors 30 and the pull rod housing 40.

As such, the insulating layer 60 can effectively isolate the first electrical connectors 30 from the pull rod housing 40, avoiding a metal piece on the pull rod housing 40 from touching the first electrical connectors 30 by mistake to cause electric leakage or short circuit.

Specifically, in an embodiment of the present application, the main function of the insulating layer 60 is to isolate the electrical connectors from the pull rod housing 40 to prevent the occurrence of current leakage and short-circuit phenomena. Through the isolation effect of the insulating layer 60, the safety of the power supply during use can be ensured.

The insulating layer 60 can also provide a certain degree of mechanical protection for the first electrical connectors 30 and the pull rod housing 40. It can withstand certain mechanical pressure and impact force, protecting the internal circuits and structures from damage.

The material of the insulating layer 60 generally has excellent heat resistance and corrosion resistance, and can adapt to various complex usage environments. This can ensure that the power supply can operate normally in various harsh environments, improving the reliability and stability of the power supply.

The material of the insulating layer 60 needs to have excellent insulating properties and mechanical strength, as well as good heat resistance and corrosion resistance. Common materials for the insulating layer 60 include rubber, plastic, ceramic, etc. These materials can effectively isolate the electrical connectors from the pull rod housing 40, preventing the occurrence of current leakage and short-circuit phenomena.

The design of the insulating layer 60 needs to consider the structure and usage environment of the power supply. In an embodiment of the present application, the insulating layer 60 should be closely attached between the electrical connectors and the pull rod housing 40, leaving no gaps. At the same time, the thickness of the insulating layer 60 also needs to be reasonably designed according to the voltage and current level of the power supply to ensure that it can withstand sufficient voltage and current impacts.

In some embodiments, the energy storage power supply 100 further includes collection boards 70 connected to the plurality of first electrical connectors 30.

As such, the provision of the collection boards 70 is beneficial to achieving real-time monitoring and data collection of the battery parameters.

Specifically, the collection boards 70 are also known as battery information collectors (BIC) or battery pack collection boards 70, which are important components in the battery management system (BMS). The collection boards 70 are connected to the battery cells 21 in the battery module 20 to collect parameters such as the voltage and temperature of the battery cells 21 in real time, and transmit these parameters to the BMS. The BMS controls and manages the battery pack in terms of charging, discharging, thermal management, etc. according to the collected data, ensuring the safe and efficient operation of the battery pack.

The collection boards 70 are mainly responsible for monitoring and collecting the state information of the battery cells 21 in the battery module 20 in real time, such as voltage, temperature and the like. Through the collection of these information, the BMS can accurately understand the operating state of the battery module 20 and perform corresponding management and control. The collection boards 70 can accurately collect parameters such as the voltage and temperature of the battery cells 21 in the battery module 20 through high-precision sensors and circuit designs. The collection boards 70 can monitor the operating state of the battery module 20 in real time, ensuring that the BMS can timely keep abreast of the operation of the battery module 20. In addition to basic voltage and temperature parameters, the collection boards 70 can also collect other parameters such as current, internal resistance and the like, providing more comprehensive state information of the battery module 20 for the BMS. The collection boards 70 usually use high-performance and high-reliability electronic devices and materials to ensure that they can still operate stably in harsh environments.

The energy storage power supply 100 can collect the state information of the battery cells 21 through the collection boards 70. The state information of the battery cells 21 can include information such as the voltage, current, temperature and the like of each of the battery cells 21. The collection boards 70 can include a first collection board and a second collection board. The first collection board is connected to the first electrical connectors 30, and the second collection board is connected to the second electrical connectors 50. After the first electrical connectors 30 and the second electrical connectors 50 are welded, the first collection board can be fixed to the corresponding position on the first electrical connectors 30 with screws, and the second collection board can be fixed to the corresponding position on the second electrical connectors 50 with screws. After the fixing of the collection boards 70 is completed, nickel strips of the first collection board and the first electrical connectors 30 can be connected by means of laser welding or other electrical connection methods, thereby achieving the electrical connection between the first collection board and the first electrical connectors 30. At the same time, the second collection board and the second electrical connectors 50 can also be connected in the same way.

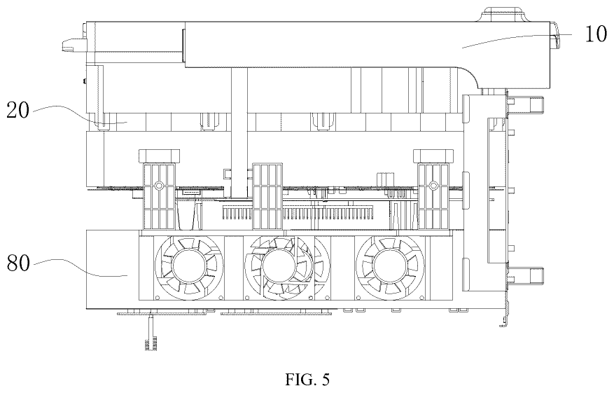

Referring to FIG. 5, in some embodiments, the energy storage power supply 100 further includes an inverter 80. The inverter 80 is provided with a heat dissipation fan, and the inverter 80 is electrically connected to the battery module 20 and mounted on the holder 22.

As such, the inverter 80 is used to assist in the heat dissipation of the battery module 20, which is beneficial to prolonging the service life of the battery module 20.

Specifically, as a device with high integration and high power, the heat dissipation performance of the energy storage power supply 100 is crucial to its stability and safety. In the design of the energy storage power supply 100, the inverter 80 is an indispensable component, especially in the battery module 20 part.

Since the battery module 20 will generate heat during operation, if the heat cannot be dissipated in a timely and effective manner, the temperature of the battery module 20 may be caused to rise, which in turn affects the performance and service life of the battery, and may even lead to safety accidents. Therefore, in an embodiment of the present application, the main function of the inverter 80 is to generate an air flow to take away the heat generated by the battery module 20, lower the temperature of the battery module 20, and ensure the stable operation of the energy storage power supply 100.

Further, the inverter 80 is spaced apart from the battery module 20, and a heat sink is further mounted on the battery module 20 and between the inverter 80 and the battery module 20.

Further, the inverter 80 is spaced apart from the heat sink. An appropriate distance between the inverter 80 and the heat sink is maintained, which can ensure that the air flow generated by the fan can fully and evenly blow over the surface of the heat sink, thereby more effectively taking away the heat on the heat sink.

The same or similar parts among the embodiments in the present specification can be referred to each other. In particular, for the device embodiments and the terminal embodiments, since they are basically similar to the method embodiments, the description of them is relatively simple.

The above are only the specific implementations of the embodiments of the present application, but the protection scope of the embodiments of the present application is not limited thereto. Any change or substitution within the technical scope disclosed in the embodiments of the present application should fall within the protection scope of the embodiments of the present application. Therefore, the protection scope of the embodiments of the present application should be subject to the protection scope defined by the claims.

What is claimed is:

1. An energy storage power supply, comprising:
a housing formed with a plurality of first positioning holes;
a battery module comprising a holder and a plurality of battery cells, wherein the holder cooperates with the housing to accommodate the plurality of battery cells, the holder is formed with a plurality of second positioning holes, each of the plurality of battery cells has a first end and a second end opposite to the first end, the first ends of the plurality of battery cells are respectively inserted into the plurality of first positioning holes, and the second ends of the plurality of battery cells are respectively inserted into the plurality of second positioning holes;
first electrical connectors disposed on one side of the housing away from the battery module and electrically connected to the first ends of the plurality of battery cells;
an inverter disposed on the holder and electrically connected to the battery module; and
a pull rod housing disposed on the housing and covering the first electrical connectors.

2. The energy storage power supply according to claim 1, wherein the pull rod housing comprises a first housing and a retractable pull rod mounted in the first housing, and the first housing covers the first electrical connectors.

3. The energy storage power supply according to claim 2, further comprising rollers mounted at a bottom of the first housing.

4. The energy storage power supply according to claim 1, further comprising a roller housing fixed to a bottom of the energy storage power supply, wherein the roller housing comprises a second housing and rollers mounted in the second housing.

5. The energy storage power supply according to claim 1, wherein the housing is fastened and connected to the holder.

6. The energy storage power supply according to claim 1, wherein the housing comprises a plurality of first connection columns, the holder comprises a plurality of second connection columns, the plurality of first connection columns are disposed at intervals between the plurality of first positioning holes, and the plurality of second connection columns are disposed at intervals between the plurality of second positioning holes.

7. The energy storage power supply according to claim 6, wherein the first connection columns are connected to the second connection columns to connect the housing to the holder.

8. The energy storage power supply according to claim 1, further comprising a second electrical connectors disposed on one side of the holder away from the battery cells and electrically connected to the second ends of the plurality of battery cells.

9. The energy storage power supply according to claim 1, further comprising an insulating layer disposed between the first electrical connectors and the pull rod housing.

10. The energy storage power supply according to claim 1, further comprising a battery management system connected to the plurality of battery cells for real-time monitoring and data collection of battery parameters.

11. An energy storage power supply, comprising:
a housing formed with a plurality of first positioning holes;
a battery module comprising a holder and a plurality of battery cells, wherein the holder cooperates with the housing to accommodate the plurality of battery cells, the holder is formed with a plurality of second positioning holes, each of the plurality of battery cells has a first end and a second end opposite to the first end, each of the plurality of battery cells has two electrodes respectively located at the first end and the second end, the first ends of the plurality of battery cells are respectively inserted into the plurality of first positioning holes, and the second ends of the plurality of battery cells are respectively inserted into the plurality of second positioning holes;
first electrical connectors disposed on one side of the housing away from the battery module and electrically connected to the first ends of the plurality of battery cells;
second electrical connectors disposed on one side of the holder away from the plurality of battery cells and electrically connected to the second ends of the plurality of battery cells; and
a pull rod housing disposed on the housing and covering the first electrical connectors.

12. The energy storage power supply according to claim 11, wherein the pull rod housing comprises a first housing and a retractable pull rod mounted in the first housing, and the first housing covers the first electrical connectors.

13. The energy storage power supply according to claim 12, further comprising rollers mounted at a bottom of the first housing.

14. The energy storage power supply according to claim 11, further comprising a roller housing fixed to a bottom of the energy storage power supply, wherein the roller housing comprises a second housing and rollers mounted in the second housing.

15. The energy storage power supply according to claim 11, wherein the housing is fastened and connected to the holder.

16. The energy storage power supply according to claim 11, wherein the housing comprises a plurality of first connection columns, the holder comprises a plurality of second connection columns, the plurality of first connection columns are disposed at intervals between the plurality of first positioning holes, and the plurality of second connection columns are disposed at intervals between the plurality of second positioning holes.

17. The energy storage power supply according to claim 16, wherein the first connection columns are connected to the second connection columns to connect the housing to the holder.

18. The energy storage power supply according to claim 11, further comprising an inverter disposed on the holder and electrically connected to the battery module.

19. The energy storage power supply according to claim 11, further comprising an insulating layer disposed between the first electrical connectors and the pull rod housing.

20. The energy storage power supply according to claim 11, further comprising a battery management system connected to the plurality of battery cells for real-time monitoring and data collection of battery parameters.
